(19) United States
(12) Patent Application Publication
(10) Pub. No.: US 2026/0162862 A1
(43) Pub. Date: Jun. 11, 2026

(54) INDUCTOR AND METHOD FOR MANUFACTURING THE SAME

(71) Applicant: CHILISIN ELECTRONICS CORP., Taoyuan City (TW)

(72) Inventors: Shou-Yi TSAO, Taoyuan City (TW); Feng HU, Hunan Province (CN); Linmei XIAO, Hunan Province (CN); Xing ZHONG, Hunan Province (CN)

(21) Appl. No.: 19/023,332

(22) Filed: Jan. 16, 2025

(30) Foreign Application Priority Data
Dec. 11, 2024 (CN) 202411817195.9

(51) Int. Cl. H01F 5/04; H01F 27/28; H01F 27/32; H01F 41/10; H01F 41/12

(52) U.S. Cl. CPC H01F 5/04; H01F 27/2823; H01F 27/327; H01F 41/10; H01F 41/127

(57) ABSTRACT

An inductor and a method for manufacturing the same are provided. The inductor includes a magnetic packaging structure, a coil embedded in the magnetic packaging structure, two extending wires connected to two ends of the coil and two encapsulation materials. The magnetic packaging structure includes a surface and two cavities on the surface. Each extending wire includes a bending part, a pin part and a fixture part connected to one another in sequence. The bending part extends to the surface from the coil and penetrates through the surface to be exposed to the outside of the magnetic packaging structure. The pin part on the surface extends to one of the cavities from the bending part. The fixture part extends to a bottom surface along with a side wall of the cavities. The encapsulation materials are disposed inside the cavities and cover the fixture part.

### CROSS-REFERENCE TO RELATED APPLICATION

This application claims priority to China Application Serial Number 202411817195.9, filed Dec. 11, 2024, which is herein incorporated by reference in its entirety.

### BACKGROUND

### Field of Invention

The present disclosure relates to an inductor, and more particularly, to an inductor including magnetic materials and the method for fabricating the inductor.

### Description of Related Art

Inductors are passive components widely used in circuit design. Different structural designs of inductors are based on different application requirements. A T-shaped magnetic core (T-core), a coil wound around the magnetic core and a packaging structure encapsulating the magnetic core and the coil are used in one of the inductor structures in present. The electrodes of this inductor are formed on the packaging structure by electroplating and are connected to the coil embedded in the packaging structure. However, since the continuity of the electroplated layer is difficult to be controlled during the electroplating process, the internal stress between the electroplated layers is large, so that the coatings on the electrodes are prone to being peeled off. As a result, it is difficult to improve the manufacturing yield of this type of inductors, and thereby working against to the mass production and the market competition.

### SUMMARY

Therefore, one objective of the present disclosure is to provide an inductor, which is advantage for higher electrode stabilities.

Another objective of the present disclosure is to provide a method for fabricating the aforementioned inductor.

An aspect of the present disclosure provides an inductor including a magnetic packaging structure including a surface and two cavities disposed on the surface. The inductor includes a coil embedded in the magnetic packaging structure. The inductor includes two extending wires connected to two ends of the coil, and each of the extending wires includes a bending part connected to the coil, a pin part connected to the bending part and disposed on the surface of the magnetic packaging structure and a fixture part connected to the pin part and extending to an inside of the one of the cavities from the pin part. The bending part extends to the surface of the magnetic packaging structure from the coil and penetrates through the surface to be exposed to an outside of the magnetic packaging structure. The pin part extends to one of the cavities from the bending part, and the pin part is connected to the coil through the bending part. The fixture part extends to a bottom surface of the one of the cavities along with a side wall of the one of the cavities, and the side wall is adjacent to the surface. The bottom surface is dented on the surface. The inductor includes two encapsulation materials disposed inside the cavities separately and covering the fixture part.

In accordance with one embodiment of the invention, the coil is a flat wire coil.

In accordance with one embodiment of the invention, an end surface of the encapsulation materials is flush with the surface of the magnetic packaging structure.

In accordance with one embodiment of the invention, the magnetic packaging structure further includes two carrier parts disposed on the surface of the magnetic packaging structure. A plane of each of the carrier parts protrudes from the surface of the magnetic packaging structure, and the pin part of each of the extending wires covers the plane of each of the carrier parts.

In accordance with one embodiment of the invention, the pin part includes a first region and two second regions. The first region is connected to one of the carrier parts of the magnetic packaging structure, and the second regions are connected to the bending part and the fixture part separately. The second regions are suspended from the surface of the magnetic packaging structure.

In accordance with one embodiment of the invention, the inductor further includes two adhesive materials separately disposed on the plane of each of the carrier parts. The adhesive materials are disposed between the carrier parts of the magnetic packaging structure and the pin of each of the extending wires.

In accordance with one embodiment of the invention, the inductor further includes a protective layer covering an outer surface of the magnetic packaging structure, and the protective layer exposes a part of the magnetic packaging structure and a part of the extending wires.

In accordance with one embodiment of the invention, the magnetic packaging structure includes a magnetic material, and the magnetic material is selected from the group consisting of iron, iron-nickel alloy, iron-cobalt alloy, iron-silicon alloy, iron-vanadium alloy, iron-silicon-chromium alloy, iron-silicon-aluminum alloy, iron-cobalt-vanadium alloy, iron-based amorphous alloy, iron-based nanocrystalline alloy, nickel-zinc ferrite, nickel-copper-zinc ferrite and manganese-zinc ferrite.

In accordance with one embodiment of the invention, the encapsulation materials include epoxy resins.

An aspect of the present disclosure provides a method for manufacturing an inductor including providing a coil structure, and the coil structure includes a coil and two extending wires connected to two ends of the coil separately. The method includes disposing a magnetic packaging structure on the coil structure, where the magnetic packaging structure comprises a surface and two cavities disposed on the surface, and the magnetic packaging structure encapsulates the coil, where the extending wires extend to the surface from the coil and penetrate the surface to be exposed to an outside of the magnetic packaging structure. The method includes bending the extending wires to the surface and inside the cavities after the magnetic packaging structure is disposed, and a bending part, a pin part and a fixture part are formed on each of the extending wires, where the bending part is connected to the coil and the pin part, and the pin part is connected to the bending part and the fixture part, and the pin part is disposed on the surface. The method includes disposing encapsulation materials inside the cavities after the bending part, the pin part and the fixture part are formed, and the encapsulation materials cover the fixture part.

In accordance with one embodiment of the invention, bending the extending wires to the surface and inside the cavities includes bending a part of the extending wires to a side wall of each of the cavities, and the pin part is formed. The side wall is adjacent to the surface. The method includes bending a part of the extending wires away from a bottom surface of each of the cavities, and the fixture part is formed, where the bottom surface is dented on the surface.

In accordance with one embodiment of the invention, the method further includes disposing one adhesive material on each of the extending wires before the extending wires are bent to the surface and inside the cavities, and the adhesive material is located between the surface of the magnetic packaging structure and the pin part after the extending wires are bent to the surface and inside the cavities.

In accordance with one embodiment of the invention, a method of disposing the magnetic packaging structure includes die casting.

Based on the above, since the coil structure of the inductor of at least one embodiment of the disclosure has a flat coil, and the extending wires are bent to be disposed on the surface of the magnetic packaging structure as the electrodes of the inductor. As a result, the electrodes of the inductor are not formed on the surface of the magnetic packaging structure by electroplating so as to save the producing cost. Moreover, a part of the extending wires as electrodes of the inductor are bent secondarily so as to form the pin part and the fixture part. The encapsulation materials are used to encapsulate the fixture part inside the cavities of the magnetic packaging structure so as to increase the bonding strength between the extending wires and the magnetic packaging structure. Therefore, the extending wires are not detached from the surface of the magnetic packaging structure in an environment with high vibration (that is, the possibility of electrode peeling is reduced), and thus improving the electrode stability of the inductor.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 illustrates a stereoscopic view of an inductor in accordance with one embodiment of the present disclosure.

FIG. 2 illustrates a cross-sectional view of the cross section C of the inductor in FIG. 1.

FIG. 3A to FIG. 3B illustrate stereoscopic views of a method for fabricating an inductor in accordance with one embodiment of the present disclosure.

FIG. 4 illustrates a flow chart of a method for fabricating an inductor in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

In the following description, the dimensions (such as lengths, widths and thicknesses) of components (such as layers, films, substrates and regions) in the drawings are enlarged not-to-scale, and the number of components may be reduced in order to clarify the technical features of the disclosure. Therefore, the following illustrations and explanations are not limited to the number of components, the number of components, the dimensions and the shapes of components, and the deviation of size and shape caused by the practical procedures or tolerances are included. For example, a flat surface shown in drawings may have rough and/or non-linear features, while angles shown in drawings may be circular. As a result, the drawings of components shown in the disclosure are mainly for illustration and not intended to accurately depict the real shapes of the components, nor are intended to limit the scope of the claimed content of the disclosure.

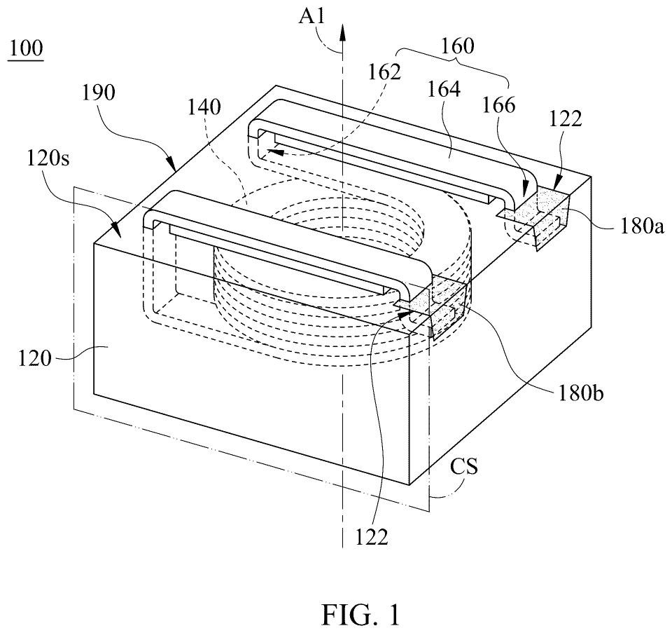

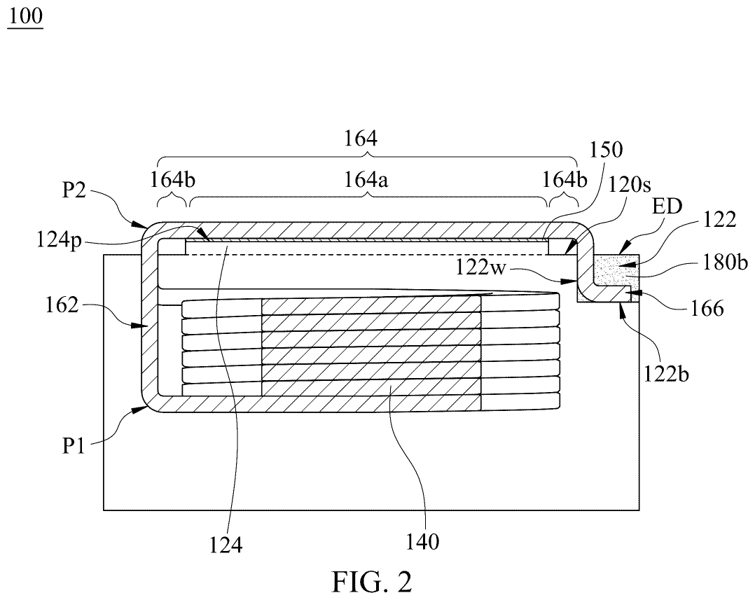

Referring to FIG. 1 and FIG. 2, where FIG. 1 illustrates an inductor 100 of at least one embodiment of the disclosure, while FIG. 2 illustrates a cross-sectional view of the inductor 100 along with the cross section C. The inductor 100 includes a magnetic packaging structure 120, a coil 140, two extending wires 160 and an encapsulation material 180a and an encapsulation material 180b. The magnetic packaging structure 120 includes a surface 120s and two cavities 122 which are disposed on the surface 120s. In various embodiments, the magnetic packaging structure 120 may be made of magnetic materials and binder materials, and the magnetic materials may include at least one of crystalline magnetic metal powders and amorphous magnetic metal powders.

Specifically, the magnetic materials may include iron, iron-nickel alloy, iron-cobalt alloy, iron-silicon alloy, iron-vanadium alloy, iron-silicon-chromium alloy, iron-silicon-aluminum alloy, iron-cobalt-vanadium alloy, iron-based amorphous alloy, iron-based nanocrystalline alloy, nickel-zinc ferrite, nickel-copper-zinc ferrite, manganese-zinc ferrite or the combination of the aforementioned alloys. The binder materials may include epoxy resin, polysilicone resin, acrylic resin, phenolic resin, polyvinyl alcohol or the combination of the aforementioned resins. It is worth mentioning that the relative magnetic permeability and the saturation magnetization of the magnetic packaging structure 120 may be modified by combing the powders with different particle sizes.

The coil 140 is embedded in the magnetic packaging structure 120, while the extending wires 160 are connected to two ends of the coil 140 separately. Specifically, the coil 140 is formed of a wire (not denoted) wound along with the axis A1 by methods of flat winding or alpha winding. The wire may include an inner conductor and a jacket insulation which is disposed on the outside of the inner conductor, but the structure of the wire is not limited to the aforementioned structure. Although the coil 140 is a flat coil (i.e., the wire of the coil 140 is a flat wire) in the embodiment, the coil 140 may be a round coil in other embodiments.

As shown in FIG. 2, each of the extending wires 160 includes a bending part 162, a pin part 164 and a fixture part 166. The bending part 162 is connected to the coil 140. In addition, the bending part 162 extends to the surface 120s of the magnetic packaging structure 120 from the coil 140 and penetrates the surface 120s to be exposed to an outside of the magnetic packaging structure 120. The pin part 164 is connected to the bending part 162 and disposed on the surface 120s of the magnetic packaging structure 120. The pin part 164 extends to one of the cavities 122 from the bending part 162, and the pin part 164 is connected to the coil 140 through the bending part 162.

In addition, the fixture part 166 is connected to the pin part 164 and extends to an inside of the one of the cavities 122 from the pin part 164. Specifically, the fixture part 166 extends to a bottom surface 122b of the one of the cavities 122 along with a side wall 122w of the one of the cavities 122. The side wall 122w of the cavity 122 is adjacent to the surface 120s, while the bottom surface 122b of the cavity 122 is dented on the surface 120s. It is worth mentioning that the pin part 164 is not connected to the coil 140 directly, while the fixture part 166 is not connected to the bending part 162 and the pin part 164 directly. That is, the bending part 162, the pin part 164 and the fixture part 166 are connected to one another in sequence from an intersection point P1 of the coil 140 and the extending wires 160.

The encapsulation material 180a and the encapsulation material 180b are disposed inside the cavities 122 separately, and the encapsulation material 180a and the encapsulation material 180b cover the fixture part 166. Referring to FIG. 1 and FIG. 2, the cavities 122 are completely filled with the encapsulation material 180a and the encapsulation material 180b, while the side wall 122w and the bottom surface 122b of the cavities 122 are covered by the encapsulation material 180a and the encapsulation material 180b. Thus, the fixture part 166 may be fixed inside the cavities 122 by the encapsulation material 180a and the encapsulation material 180b so as to increase the bonding strength between the extending wires 160 and the magnetic packaging structure 120. Furthermore, although an end surface ED of the encapsulation material 180a (or the encapsulation material 180b) is flush with the surface 120s of the magnetic packaging structure 120, the disclosure is not limited to the embodiment. In other embodiments, the end surface ED may protrude from or be dented on the surface 120s of the magnetic packaging structure 120. The encapsulation material 180a and the encapsulation material 180b may include but not limited to epoxy resins.

It is worth mentioning that a bending point P2 included in the bending part 162 of the extending wires 160 is not a right angle but an arc. The magnetic packaging structure 120 may further include two carrier parts 124 so as to make the pin part 164 of the extending wires 160 appressed to the magnetic packaging structure 120. The carrier parts 124 are disposed on the surface 120s of the magnetic packaging structure 120. A plane 124p of each of the carrier parts 124 protrudes from the surface 120s of the magnetic packaging structure 120, while the pin part 164 of the extending wires 160 covers the plane 124p of the carrier parts 124. Thus, the pin part 164 may be appressed to the magnetic packaging structure 120, even though the bending point P2 included in the bending part 162 is not a right angle.

However, the aforementioned carrier parts 124 may make a part of the pin part 164 suspended from the surface 120s of the magnetic packaging structure 120. Specifically, the pin part 164 includes a first region 164a and two second regions 164b, while the first region 164a is connected to the carrier parts 124 of the magnetic packaging structure 120. Further, two second regions 164b are separately connected to the bending part 162 and the fixture part 166, and the second regions 164b are suspended from the surface 120s of the magnetic packaging structure 120. It is worth mentioning, although a part of the pin part 164 is suspended from the surface 120s of the magnetic packaging structure 120, the disclosure is not limited to the embodiment. In other embodiments, two ends of the carrier parts 124 (i.e., the left end and the right end of the carrier parts 124 in FIG. 2) may separately extend to two ends of the pin part 164 (i.e., the left end and the right end of the pin part 164 in FIG. 2), so that the pin part 164 may not be suspended from the surface 120s of the magnetic packaging structure 120.

As shown in FIG. 2, the inductor 100 further includes two adhesive materials 150. The adhesive materials 150 are separately disposed on the plane 124p of the carrier parts 124. The adhesive materials 150 are located between the carrier parts 124 of the magnetic packaging structure 120 and the pin part 164 of the extending wires 160 so as to adhere the carrier parts 124 of the magnetic packaging structure 120 to the pin part 164 of the extending wires 160. The adhesive materials 150 may include nickel, tin, similar soldering metals or other non-metallic materials, such as epoxy, polyimide or similar adhesive materials. It is worth mentioning that the inductor 100 is not limited to include the adhesive materials 150 in various embodiments. In other words, in some embodiments, the adhesive materials 150 may be excluded from the inductor 100. Thus, the plane 124p of the carrier parts 124 may directly touch the pin part 164 of the extending wires 160 (not shown).

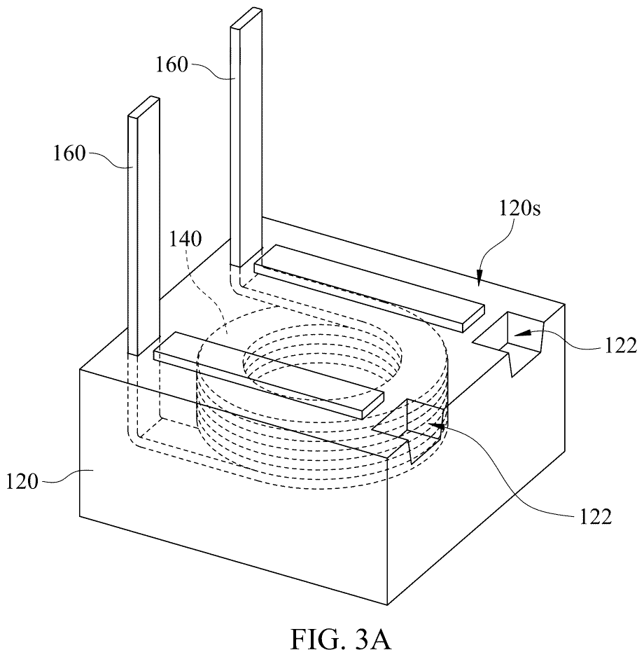

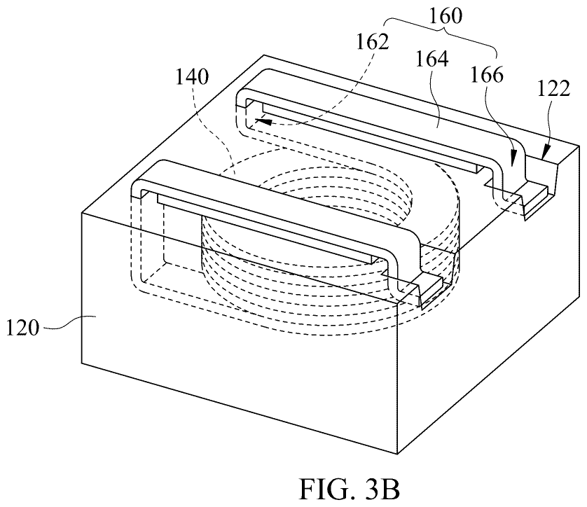

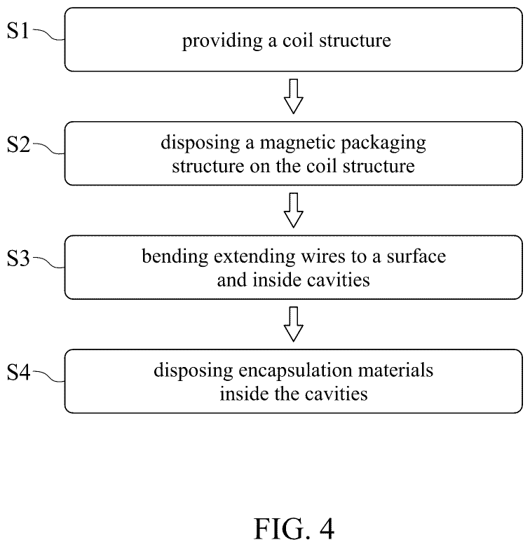

The method for fabricating the inductor 100 is illustrated by FIG. 3A to FIG. 3B, while FIG. 4 illustrates a flow chart of the method for fabricating the inductor 100. Referring to FIG. 4, firstly, the step S1 is providing a coil structure, and the coil structure includes a coil and two extending wires. Next, the step S2 is disposing the magnetic packaging structure on the coil structure, and the magnetic packaging structure includes a surface and two cavities which are disposed on the surface. Next, the step S3 is bending the extending wires to the surface and inside the cavities so as to form a bending part, a pin part and a fixture part on each of the extending wires. Next, the step S4 is disposing encapsulation materials inside the cavities. Each of the aforementioned steps is illustrated in the following description.

Referring to FIG. 3A, firstly, the coil structure (not denoted) is provided, and the coil structure includes the coil 140 and two extending wires 160. The extending wires 160 are connected to two ends of the coil 140 separately. Next, the magnetic packaging structure 120 is disposed on the coil structure by die casting.

The steps of die casting include disposing the coil structure inside the die cavity of a die, and the die cavity is filled with the powders which are selected to form the magnetic packaging structure 120. The powders include magnetic materials and binder materials. Next, the powders inside the die cavity are pressed and squeezed by stamping machine, so that the powders encapsulates a part of the coil structure (including the coil 140 and a part of the extending wires 160), and an initial packaging body (not shown) is formed. The powders are pressed and squeezed to fill the spacing between the die cavity and the coil structure by the pressure from the stamping machine. After the processes of forming the initial packaging body, such as cold casting or hot casting under various temperatures, the initial packaging body is taken out from the die.

In addition, in the steps of die casting of the embodiment, the initial packaging body may be treated by heat treatments, such as curing, after being taken out from the die. Thus, the initial packaging body may be cured so as to form the magnetic packaging structure 120. The magnetic packaging structure 120 encapsulates the coil 140 and includes the surface 120s and the cavities 122 on the surface 120s. The extending wires 160 extend to the surface 120s from the coil 140 and penetrate the surface 120s to be exposed to the outside of the magnetic packaging structure 120.

Next, in some embodiments, a protective layer may be formed on the outer surface (including the surface 120s) of the magnetic packaging structure 120 by spray coating. The protective layer may include insulation materials, such as epoxy resins. Furthermore, in some embodiments, the protective layer may be formed on the extending wires 160 which are exposed to the outside of the magnetic packaging structure 120. After the protective layer is formed, a part of the protective layer may be removed by methods, such as laser cutting or laser ablation, so that a part of the magnetic packaging structure 120 (i.e., the cavities 122 of the magnetic packaging structure 120) and a part of the extending wires 160 are exposed. It is worth mentioning, the methods of other embodiments further include cutting the extending wires 160 by terminal cutting so as to adjust the length of the extending wires 160 which is exposed to the outside of the magnetic packaging structure 120.

Referring to FIG. 3B, the extending wires 160 may be bent to the surface 120s and inside the cavities 122 by machining after the magnetic packaging structure 120 is disposed, so that the bending part 162, the pin part 164 and the fixture part 166 are formed on each of the extending wires 160. The bending part 162 is connected to the coil 140 and the pin part 164, while the pin part 164 is connected to the bending part 162 and the fixture part 166, where the pin part 164 is disposed on the surface 120s.

The adhesive materials 150 (shown in FIG. 2) may be disposed on the extending wires 160 by methods, such as immersion tin or spread coating, before the extending wires 160 are bent to the surface 120s and inside the cavities 122. Thus, the adhesive materials 150 may be located between the surface 120s of the magnetic packaging structure 120 and the pin part 164 after the extending wires 160 are bent to the surface 120s and inside the cavities 122. In other words, disposing the adhesive materials 150 on the extending wires 160 may make the extending wires 160 exposed to the outside of the magnetic packaging structure 120 adhered to the magnetic packaging structure 120. However, the adhesive materials 150 are not limited to be disposed on the extending wires 160 of the disclosure. In some embodiments, the adhesive materials 150 may be disposed on the surface 120s of the magnetic packaging structure 120 or on the carrier parts 124 (denoted in FIG. 2) so as to make the extending wires 160 adhered to the magnetic packaging structure 120.

Specifically, the step of bending the extending wires 160 to the surface 120s and inside the cavities 122 may include bending a part of the extending wires 160 to the side wall 122w (denoted in FIG. 2) of the cavities 122 so as to form the pin part 164. In addition, the step further includes bending a part of the extending wires 160 away from the bottom surface 122b (denoted in FIG. 2) of the cavities 122 so as to form the fixture part 166. The side wall 122w is adjacent to the surface 120s, while the bottom surface 122b is dented on the surface 120s.

The encapsulation material 180a and the encapsulation material 180b (shown in FIG. 1) are separately disposed inside the cavities 122 by dispensing after the bending part 162, the pin part 164 and the fixture part 166 are formed. Next, the encapsulation material 180a and the encapsulation material 180b cover the fixture part 166 by curing. Consequently, the inductor 100 of at least one embodiment of the disclosure has been substantially completed.

Accordingly, since the coil structure of the inductor of at least one embodiment of the disclosure has a flat coil, and the extending wires are bent to be disposed on the surface of the magnetic packaging structure as the electrodes of the inductor. As a result, the electrodes of the inductor are not formed on the surface of the magnetic packaging structure by electroplating so as to save the producing cost. Moreover, a part of the extending wires as electrodes of the inductor are bent secondarily so as to form the pin part and the fixture part. The encapsulation materials are used to encapsulate the fixture part inside the cavities of the magnetic packaging structure so as to increase the bonding strength between the extending wires and the magnetic packaging structure. Therefore, the extending wires are not detached from the surface of the magnetic packaging structure in an environment with high vibration (that is, the possibility of electrode peeling is reduced), and thus improving the electrode stability of the inductor and the manufacturing yield.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. An inductor, comprising:
a magnetic packaging structure comprising a surface and two cavities disposed on the surface;
a coil embedded in the magnetic packaging structure;
two extending wires connected to two ends of the coil, and each of the extending wires comprises:
a bending part connected to the coil, wherein the bending part extends to the surface of the magnetic packaging structure from the coil and penetrates through the surface to be exposed to an outside of the magnetic packaging structure;
a pin part connected to the bending part and disposed on the surface of the magnetic packaging structure, wherein the pin part extends to one of the cavities from the bending part, and the pin part is connected to the coil through the bending part;
a fixture part connected to the pin part and extending to an inside of the one of the cavities from the pin part, wherein the fixture part extends to a bottom surface of the one of the cavities along with a side wall of the one of the cavities, and the side wall is adjacent to the surface, wherein the bottom surface is dented on the surface; and
two encapsulation materials disposed inside the cavities separately and covering the fixture part.

2. The inductor of claim 1, wherein the coil is a flat wire coil.

3. The inductor of claim 1, wherein an end surface of the encapsulation materials is flush with the surface of the magnetic packaging structure.

4. The inductor of claim 1, wherein the magnetic packaging structure further comprises:
two carrier parts disposed on the surface of the magnetic packaging structure, wherein a plane of each of the carrier parts protrudes from the surface of the magnetic packaging structure, and the pin part of each of the extending wires covers the plane of each of the carrier parts.

5. The inductor of claim 4, wherein the pin part comprises:
a first region connected to one of the carrier parts of the magnetic packaging structure; and
two second regions connected to the bending part and the fixture part separately, wherein the second regions are suspended from the surface of the magnetic packaging structure.

6. The inductor of claim 4, further comprising:
two adhesive materials separately disposed on the plane of each of the carrier parts, wherein the adhesive materials are disposed between the carrier parts of the magnetic packaging structure and the pin of each of the extending wires.

7. The inductor of claim 1, further comprising:
a protective layer covering an outer surface of the magnetic packaging structure, and the protective layer exposes a part of the magnetic packaging structure and a part of the extending wires.

8. The inductor of claim 1, wherein the magnetic packaging structure comprises a magnetic material, and the magnetic material is selected from the group consisting of iron, iron-nickel alloy, iron-cobalt alloy, iron-silicon alloy, iron-vanadium alloy, iron-silicon-chromium alloy, iron-silicon-aluminum alloy, iron-cobalt-vanadium alloy, iron-based amorphous alloy, iron-based nanocrystalline alloy, nickel-zinc ferrite, nickel-copper-zinc ferrite and manganese-zinc ferrite.

9. The inductor of claim 1, wherein the encapsulation materials comprise epoxy resins.

10. A method for manufacturing an inductor, comprising:
providing a coil structure, and the coil structure comprises:
a coil; and
two extending wires connected to two ends of the coil separately;
disposing a magnetic packaging structure on the coil structure, wherein the magnetic packaging structure comprises a surface and two cavities disposed on the surface, and the magnetic packaging structure encapsulates the coil, wherein the extending wires extend to the surface from the coil and penetrate the surface to be exposed to an outside of the magnetic packaging structure;
bending the extending wires to the surface and inside the cavities after the magnetic packaging structure is disposed, and a bending part, a pin part and a fixture part are formed on each of the extending wires, wherein the bending part is connected to the coil and the pin part, and the pin part is connected to the bending part and the fixture part, and the pin part is disposed on the surface; and
disposing encapsulation materials inside the cavities after the bending part, the pin part and the fixture part are formed, and the encapsulation materials cover the fixture part.

11. The method of claim 10, wherein bending the extending wires to the surface and inside the cavities comprises:
bending a part of the extending wires to a side wall of each of the cavities, and the pin part is formed, wherein the side wall is adjacent to the surface; and
bending a part of the extending wires away from a bottom surface of each of the cavities, and the fixture part is formed, wherein the bottom surface is dented on the surface.

12. The method of claim 10, further comprising:
disposing one adhesive material on each of the extending wires before the extending wires are bent to the surface and inside the cavities, and the adhesive material is located between the surface of the magnetic packaging structure and the pin part after the extending wires are bent to the surface and inside the cavities.

13. The method of claim 10, wherein a method of disposing the magnetic packaging structure comprises die casting.
